(19) United States
(12) Patent Application Publication
(10) Pub. No.: US 2011/0234481 A1
(43) Pub. Date: Sep. 29, 2011

(54) ENHANCING PRESENTATIONS USING DEPTH SENSING CAMERAS

(76) Inventors: Sagi Katz, Yokneam Ilit (IL); Avishai Adler, Haifa (IL)

(21) Appl. No.: 12/748,231

(22) Filed: Mar. 26, 2010

(51) Int. Cl. G09G 5/00; H04N 3/23

(52) U.S. Cl. 345/156; 348/746

(57) ABSTRACT

A depth camera and an optional visual camera are used in conjunction with a computing device and projector to display a presentation and automatically correct the geometry of the projected presentation. Interaction with the presentation (switching slides, pointing, etc.) is achieved by utilizing gesture recognition/human tracking based on the output of the depth camera and (optionally) the visual camera. Additionally, the output of the depth camera and/or visual camera can be used to detect occlusions between the projector and the screen (or other target area) in order to adjust the presentation to not project on the occlusion and, optionally, reorganize the presentation to avoid the occlusion.

### BACKGROUND

In business, education and other situations, people often make presentations using one or more software applications. Typically, the software will be run on a computer connected to a projector and a set of slides will be projected on a screen. In some instances, however, the projection of the slides can be distorted due to the geometry of the screen or position of the projector.

Often, the person making the presentation (referred to as the presenter) desires to stand in front of the screen. When doing so, a portion of the presentation may be projected on to the presenter, which makes the presentation difficult to see and may make the presenter uncomfortable because of the high intensity light directed at their eyes. Additionally, if the presenter is by the screen, then the presented will have trouble controlling the presentation and pointing to portions of the presentation to highlight those portions of the presentation.

### SUMMARY

A presentation system is provided that uses a depth camera and (optionally) a visual camera in conjunction with a computer and projector (or other display device) to automatically adjust the geometry of a projected presentation and provide for interaction with the presentation based on gesture recognition and/or human tracking technology.

One embodiment includes displaying a visual presentation, automatically detecting that the displayed visual presentation is visually distorted and automatically correcting the displayed visual presentation to fix the detected distortion.

One embodiment includes a processor, a display device in communication with the processor, a depth camera in communication with the processor, and a memory device in communication with the processor. The memory device stores a presentation. The processor causes the presentation to be displayed by the display device. The processor receives depth images from the depth camera and recognizes one or more gestures made by a human in a field of view of the depth camera. The processor performs one or more actions to adjust the presentation based on the recognized one or more gestures.

One embodiment includes receiving a depth image, automatically detecting an occlusion between a projector and a target area using the depth image, automatically adjusting a presentation in response to and based on detecting the occlusion so that the presentation will not be projected on the occlusion, and displaying the adjusted presentation on the target area without displaying the presentation on the occlusion.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram of one embodiment of a capture device, projection system and computing system.

FIG. 2 is a block diagram of one embodiment of a computing system and an integrated capture device and projection system.

FIG. 3 depicts an example of a skeleton.

FIG. 4 illustrates an example embodiment of a computing system that may be used to track motion and update an application based on the tracked motion.

FIG. 5 illustrates another example embodiment of a computing system that may be used to track motion and update an application based on the tracked motion.

FIG. 6 is a flow chart describing one embodiment of a process for providing, interacting with and adjusting a presentation.

FIG. 7A is a flow chart describing one embodiment of a process for automatically adjusting a presentation to correct for distortion.

FIG. 7B is a flow chart describing one embodiment of a process for automatically adjusting a presentation to correct for distortion.

FIG. 8A depicts a distorted presentation.

FIG. 8B depicts a presentation that has been adjusted to correct distortion.

FIG. 9 is a flow chart describing one embodiment of a process for accounting for occlusions during a presentation.

FIG. 9A is a flow chart describing one embodiment of a process for automatically adjusting a presentation in response to and based on detecting an occlusion so that the presentation will not be projected on the occlusion.

FIG. 9B is a flow chart describing one embodiment of a process for automatically adjusting a presentation in response to and based on detecting an occlusion so that the presentation will not be projected on the occlusion.

FIG. 10A depicts a presentation being occluded by a person.

FIG. 10B depicts a presentation that has been adjusted in response to the occlusion.

FIG. 10C depicts a presentation that has been adjusted in response to the occlusion.

FIG. 11 is a flow chart describing one embodiment of a process for interacting with a presentation using gestures.

FIG. 12 is a flow chart describing one embodiment of a process for highlighting a portion of a presentation.

FIG. 13 depicts a presentation with a portion of the presentation being highlighted.

### DETAILED DESCRIPTION

A presentation system is provided that uses a depth camera and (optionally) a visual camera in conjunction with a computer and projector (or other display device). The use of the depth camera and (optional) visual camera allows the system to automatically correct the geometry of the projected presentation. Interaction with the presentation (switching slides, pointing, etc.) is achieved by utilizing gesture recognition/human tracking based on the output of the depth camera and (optionally) the visual camera. Additionally, the output of the depth camera and/or visual camera can be used to detect occlusions (e.g., the presenter) between the projector and the screen (or other target area) in order to adjust the presentation to not project on the occlusion and, optionally, reorganize the presentation to avoid the occlusion.

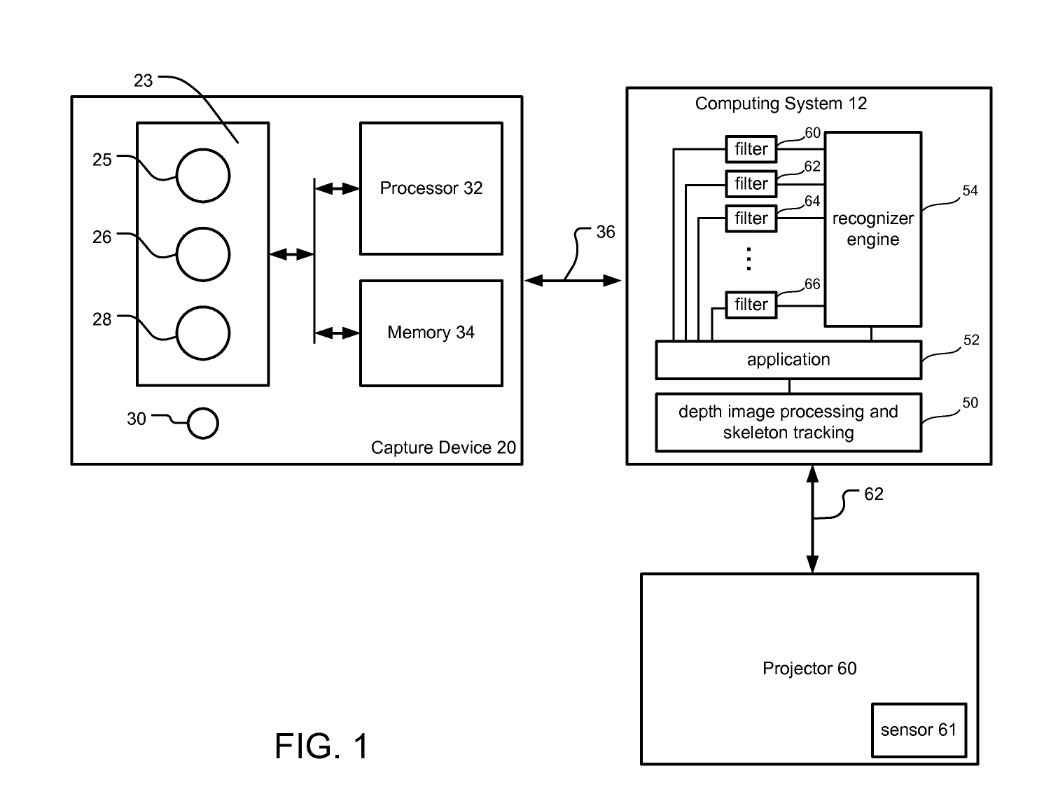

FIG. 1 is a block diagram of one embodiment of a presentation system that includes computing system 12 connected to and in communication with capture device 20 and projector 60.

In one embodiment, capture device 20 may be configured to capture video with depth information including a depth image that may include depth values via any suitable technique including, for example, time-of-flight, structured light, stereo image, or the like. According to one embodiment, the capture device 20 may organize the depth information into “Z layers,” or layers that may be perpendicular to a Z axis extending from the depth camera along its line of sight.

As shown in FIG. 1, the capture device 20 may include a camera component 23. According to an example embodiment, the camera component 23 may be a depth camera that may capture a depth image of a scene. The depth image may include a two-dimensional (2-D) pixel area of the captured scene where each pixel in the 2-D pixel area may represent a depth value such as a distance in, for example, centimeters, millimeters, or the like of an object in the captured scene from the camera.

As shown in FIG. 1, according to an example embodiment, the image camera component 23 may include an infra-red (IR) light component 25, a three-dimensional (3-D) camera 26, and an RGB (visual image) camera 28 that may be used to capture the depth image of a scene, as well as a visual image. For example, in time-of-flight analysis, the IR light component 25 of the capture device 20 may emit an infrared light onto the scene and may then use sensors (not shown) to detect the backscattered light from the surface of one or more targets and objects in the scene using, for example, the 3-D camera 26 and/or the RGB camera 28. In some embodiments, pulsed infrared light may be used such that the time between an outgoing light pulse and a corresponding incoming light pulse may be measured and used to determine a physical distance from the capture device 20 to a particular location on the targets or objects in the scene. Additionally, in other example embodiments, the phase of the outgoing light wave may be compared to the phase of the incoming light wave to determine a phase shift. The phase shift may then be used to determine a physical distance from the capture device to a particular location on the targets or objects.

According to another example embodiment, time-of-flight analysis may be used to indirectly determine a physical distance from the capture device 20 to a particular location on the targets or objects by analyzing the intensity of the reflected beam of light over time via various techniques including, for example, shuttered light pulse imaging.

In another example embodiment, the capture device 20 may use a structured light to capture depth information. In such an analysis, patterned light (i.e., light displayed as a known pattern such as grid pattern, a stripe pattern, or different pattern) may be projected onto the scene via, for example, the IR light component 25. Upon striking the surface of one or more targets or objects in the scene, the pattern may become deformed in response. Such a deformation of the pattern may be captured by, for example, the 3-D camera 26 and/or the RGB camera 28 (and/or other sensor) and may then be analyzed to determine a physical distance from the capture device to a particular location on the targets or objects. In some implementations, the IR Light component 25 is displaced from the cameras 26 and 28 so triangulation can be used to determined distance from cameras 26 and 28. In some implementations, the capture device 20 will include a dedicated IR sensor to sense the IR light, or a sensor with an IR filter.

According to another embodiment, the capture device 20 may include two or more physically separated cameras that may view a scene from different angles to obtain visual stereo data that may be resolved to generate depth information. Other types of depth image sensors can also be used to create a depth image.

The capture device 20 may further include a microphone 30. The microphone 30 may include a transducer or sensor that may receive and convert sound into an electrical signal. According to one embodiment, the microphone 30 may be used to reduce feedback between the capture device 20 and the computing system 12 in the target recognition, analysis, and tracking system 10. Additionally, the microphone 30 may be used to receive audio signals that may also be provided by to computing system 12.

In an example embodiment, the capture device 20 may further include a processor 32 that may be in communication with the image camera component 23. Processor 32 may include a standardized processor, a specialized processor, a microprocessor, or the like that may execute instructions including, for example, instructions for receiving a depth image, generating the appropriate data format (e.g., frame) and transmitting the data to computing system 12.

Capture device 20 may further include a memory component 34 that may store the instructions that are executed by processor 32, images or frames of images captured by the 3-D camera and/or RGB camera, or any other suitable information, images, or the like. According to an example embodiment, the memory component 34 may include random access memory (RAM), read only memory (ROM), cache, flash memory, a hard disk, or any other suitable storage component. As shown in FIG. 1, in one embodiment, memory component 34 may be a separate component in communication with the image capture component 22 and the processor 32. According to another embodiment, the memory component 34 may be integrated into processor 32 and/or the image capture component 22.

As shown in FIG. 1, capture device 20 may be in communication with the computing system 12 via a communication link 36. The communication link 36 may be a wired connection including, for example, a USB connection, a Firewire connection, an Ethernet cable connection, or the like and/or a wireless connection such as a wireless 802.11b, g, a, or n connection. According to one embodiment, the computing system 12 may provide a clock to the capture device 20 that may be used to determine when to capture, for example, a scene via the communication link 36. Additionally, the capture device 20 provides the depth information and visual (e.g., RGB) images captured by, for example, the 3-D camera 26 and/or the RGB camera 28 to the computing system 12 via the communication link 36. In one embodiment, the depth images and visual images are transmitted at 30 frames per second. The computing system 12 may then use the model, depth information, and captured images to, for example, control an application such as presentation software.

Computing system 12 includes depth image processing and skeletal tracking module 50, which uses the depth images to track one or more persons detectable by the depth camera. Depth image processing and skeletal tracking module 50 provides the tracking information to application 52, which can be a presentation software application such as PowerPoint by Microsoft Corporation. The audio data and visual image data is also provided to application 52, depth image processing and skeletal tracking module 50, and recognizer engine 54. Application 52 or depth image processing and skeletal tracking module 50 can also provide the tracking information, audio data and visual image data to recognizer engine 54. In another embodiment, recognizer engine 54 receives the tracking information directly from depth image processing and skeletal tracking module 50 and receives the audio data and visual image data directly from capture device 20.

Recognizer engine 54 is associated with a collection of filters 60, 62, 64, . . . , 66 each comprising information concerning a gesture, action or condition that may be performed by any person or object detectable by capture device 20. For example, the data from capture device 20 may be processed by filters 60, 62, 64, . . . , 66 to identify when a user or group of users has performed one or more gestures or other actions. Those gestures may be associated with various controls, objects or conditions of application 52. Thus, the computing environment 12 may use the recognizer engine 54, with the filters, to interpret movements.

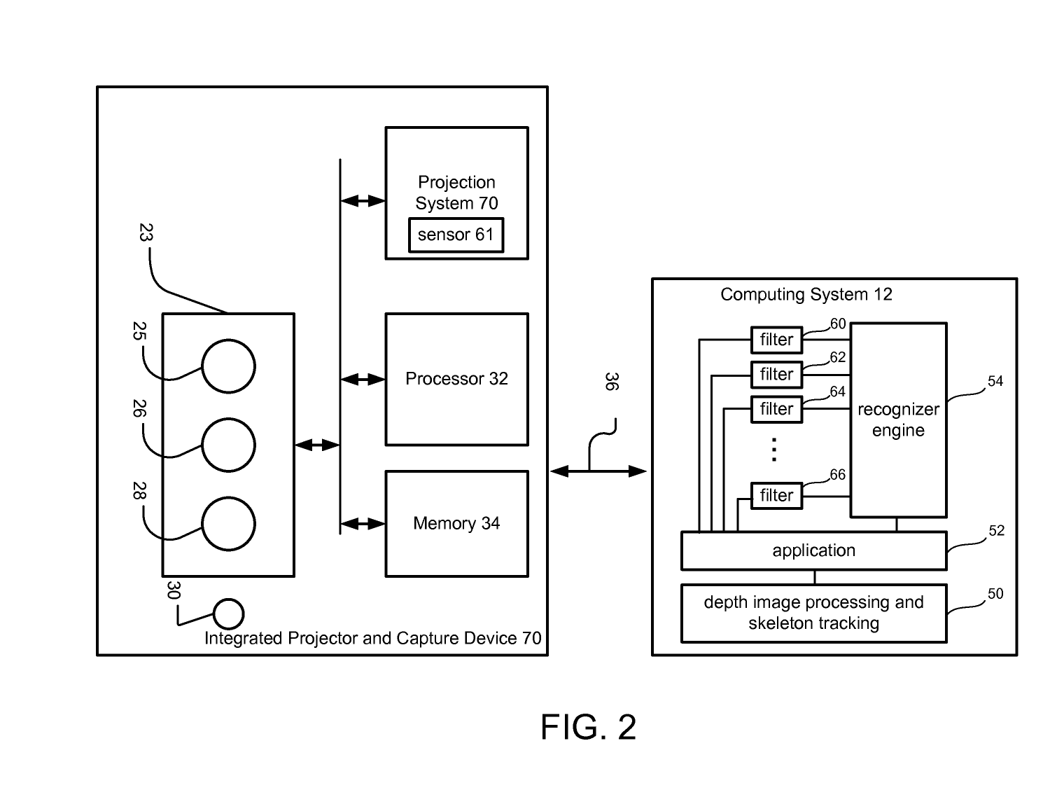

Capture device 20 of FIG. 2 provides RGB images (or visual images in other formats or color spaces) and depth images to computing system 12. The depth image may be a plurality of observed pixels where each observed pixel has an observed depth value. For example, the depth image may include a two-dimensional (2-D) pixel area of the captured scene where each pixel in the 2-D pixel area may have a depth value such as distance of an object in the captured scene from the capture device.

FIG. 2 is a block diagram of a second embodiment of a presentation system. The system of FIG. 2 is similar to the system of FIG. 1, except that the projection system 70 is integrated in the capture device 70. Thus, processor 32 can communicate with projection system 70 to configure and receive feedback from projection system 70.

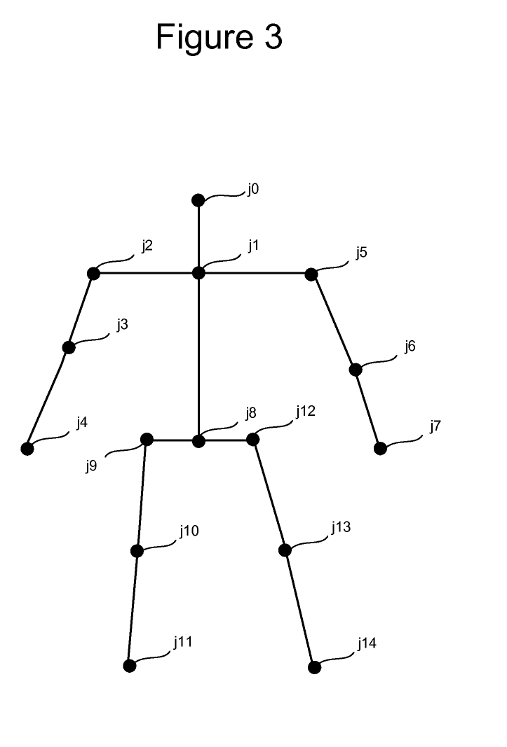

The system (either the system of the FIG. 1 or the system of FIG. 2) will use the RGB images and depth images to track a user's movements. For example, the system will track a skeleton of a person using the depth images. There are many methods that can be used to track the skeleton of a person using depth images. One suitable example of tracking a skeleton using depth image is provided in U.S. patent application Ser. No. 12/603,437, “Pose Tracking Pipeline” filed on Oct. 21, 2009, Craig, et al. (hereinafter referred to as the '437 Application), incorporated herein by reference in its entirety. The process of the '437 Application includes acquiring a depth image, down sampling the data, removing and/or smoothing high variance noisy data, identifying and removing the background, and assigning each of the foreground pixels to different parts of the body. Based on those steps, the system will fit a model to the data and create a skeleton. The skeleton will include a set of joints and connections between the joints. FIG. 3 shows an example skeleton with 15 joints (j0, j1, j2, j3, j4, j5, j6, j7, j8, j9, j10, j11, j12, j13, and j14). Each of the joints represents a place in the skeleton where the skeleton can pivot in the x, y, z directions or a place of interest on the body. Other methods for tracking can also be used. Suitable tracking technology is also disclosed in the following four U.S. patent applications, all of which are incorporated herein by reference in their entirety: U.S. patent application Ser. No. 12/475,308, “Device for Identifying and Tracking Multiple Humans Over Time,” filed on May 29, 2009; U.S. patent application Ser. No. 12/696,282, “Visual Based Identity Tracking,” filed on Jan. 29, 2010; U.S. patent application Ser. No. 12/641,788, “Motion Detection Using Depth Images,” filed on Dec. 18, 2009; and U.S. patent application Ser. No. 12/575,388, “Human Tracking System,” filed on Oct. 7, 2009.

Recognizer engine 54 includes multiple filters 60, 62, 64, . . . , 66 to determine a gesture or action. A filter comprises information defining a gesture, action or condition along with parameters, or metadata, for that gesture, action or condition. For instance, a wave, which comprises motion of one of the hands from one side to another may be a gesture recognized using one of the filters. Additionally, a pointing motion may be another gesture that can be recognized by one of the filters. Parameters may then be set for that gesture. Where the gesture is a wave, a parameter may be a threshold velocity that the hand has to reach, a distance the hand must travel (either absolute, or relative to the size of the user as a whole), and a confidence rating by the recognizer engine that the gesture occurred. These parameters for the gesture may vary between applications, between contexts of a single application, or within one context of one application over time.

Filters may be modular or interchangeable. In one embodiment, a filter has a number of inputs (each of those inputs having a type) and a number of outputs (each of those outputs having a type). A first filter may be replaced with a second filter that has the same number and types of inputs and outputs as the first filter without altering any other aspect of the recognizer engine architecture. A filter need not have any parameters.

Inputs to a filter may comprise things such as joint data about a user's joint position, angles formed by the bones that meet at the joint, RGB color data from the scene, and the rate of change of an aspect of the user. Outputs from a filter may comprise things such as the confidence that a given gesture is being made, the speed at which a gesture motion is made, and a time at which a gesture motion is made.

The recognizer engine 54 may have a base recognizer engine that provides functionality to the filters. In one embodiment, the functionality that the recognizer engine 54 implements includes an input-over-time archive that tracks recognized gestures and other input, a Hidden Markov Model implementation (where the modeled system is assumed to be a Markov process—one where a present state encapsulates any past state information necessary to determine a future state, so no other past state information must be maintained for this purpose—with unknown parameters, and hidden parameters are determined from the observable data), as well as other functionality required to solve particular instances of gesture recognition.

Filters 60, 62, 64, . . . , 66 are loaded and implemented on top of the recognizer engine 54 and can utilize services provided by recognizer engine 54 to all filters 60, 62, 64, . . . , 66. In one embodiment, recognizer engine 54 receives data to determine whether it meets the requirements of any filter 60, 62, 64, . . . , 66. Since these provided services, such as parsing the input, are provided once by recognizer engine 54 rather than by each filter 60, 62, 64, . . . , 66, such a service need only be processed once in a period of time as opposed to once per filter for that period, so the processing required to determine gestures is reduced.

Application 52 may use the filters 60, 62, 64, . . . , 66 provided with the recognizer engine 54, or it may provide its own filter, which plugs in to recognizer engine 54. In one embodiment, all filters have a common interface to enable this plug-in characteristic. Further, all filters may utilize parameters, so a single gesture tool below may be used to debug and tune the entire filter system.

More information about recognizer engine 54 can be found in U.S. patent application Ser. No. 12/422,661, “Gesture Recognizer System Architecture,” filed on Apr. 13, 2009, incorporated herein by reference in its entirety. More information about recognizing gestures can be found in U.S. patent application Ser. No. 12/391,150, “Standard Gestures,” filed on Feb. 23, 2009; and U.S. patent application Ser. No. 12/474,655, “Gesture Tool” filed on May 29, 2009, both of which are incorporated herein by reference in their entirety.

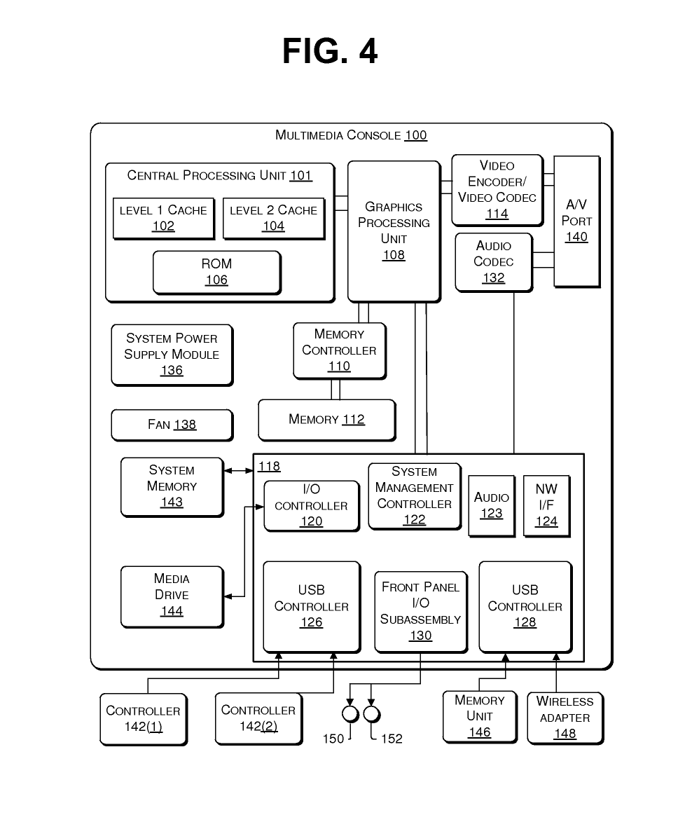

FIG. 4 illustrates an example embodiment of a computing system that may be the computing system 12 shown in FIGS. 1 and 2. The computing system such as the computing system 12 described above with respect to FIGS. 1 and 2 may be a multimedia console 100. As shown in FIG. 4, the multimedia console 100 has a central processing unit (CPU) 101 having a level 1 cache 102, a level 2 cache 104, and a flash ROM (Read Only Memory) 106. The level 1 cache 102 and a level 2 cache 104 temporarily store data and hence reduce the number of memory access cycles, thereby improving processing speed and throughput. The CPU 101 may be provided having more than one core, and thus, additional level 1 and level 2 caches 102 and 104. The flash ROM 106 (one or more ROM chips) may store executable code that is loaded during an initial phase of a boot process when the multimedia console 100 is powered on.

A graphics processing unit (GPU) 108 and a video encoder/video codec (coder/decoder) 114 form a video processing pipeline for high speed and high resolution graphics processing. Data is carried from the graphics processing unit 108 to the video encoder/video codec 114 via a bus. The video processing pipeline outputs data to an A/V (audio/video) port 140 for transmission to a television or other display. A memory controller 110 is connected to the GPU 108 to facilitate processor access to various types of memory 112, such as, but not limited to, a RAM (Random Access Memory).

The multimedia console 100 includes an I/O controller 120, a system management controller 122, an audio processing unit 123, a network interface controller 124, a first USB host controller 126, a second USB controller 128 and a front panel I/O subassembly 130 that are preferably implemented on a module 118. The USB controllers 126 and 128 serve as hosts for peripheral controllers 142(1)-142(2), a wireless adapter 148, and an external memory device 146 (e.g., flash memory, external CD/DVD ROM drive, removable media, etc.). The network interface 124 and/or wireless adapter 148 provide access to a network (e.g., the Internet, home network, etc.) and may be any of a wide variety of various wired or wireless adapter components including an Ethernet card, a modem, a Bluetooth module, a cable modem, and the like.

System memory 143 is provided to store application data that is loaded during the boot process. A media drive 144 is provided and may comprise a DVD/CD drive, Blu-Ray drive, hard disk drive, or other removable media drive, etc. The media drive 144 may be internal or external to the multimedia console 100. Application data may be accessed via the media drive 144 for execution, playback, etc. by the multimedia console 100. The media drive 144 is connected to the I/O controller 120 via a bus, such as a Serial ATA bus or other high speed connection (e.g., IEEE 1394).

The system management controller 122 provides a variety of service functions related to assuring availability of the multimedia console 100. The audio processing unit 123 and an audio codec 132 form a corresponding audio processing pipeline with high fidelity and stereo processing. Audio data is carried between the audio processing unit 123 and the audio codec 132 via a communication link. The audio processing pipeline outputs data to the A/V port 140 for reproduction by an external audio user or device having audio capabilities.

The front panel I/O subassembly 130 supports the functionality of the power button 150 and the eject button 152, as well as any LEDs (light emitting diodes) or other indicators exposed on the outer surface of the multimedia console 100. A system power supply module 136 provides power to the components of the multimedia console 100. A fan 138 cools the circuitry within the multimedia console 100.

The CPU 101, GPU 108, memory controller 110, and various other components within the multimedia console 100 are interconnected via one or more buses, including serial and parallel buses, a memory bus, a peripheral bus, and a processor or local bus using any of a variety of bus architectures. By way of example, such architectures can include a Peripheral Component Interconnects (PCI) bus, PCI-Express bus, etc.

When the multimedia console 100 is powered on, application data may be loaded from the system memory 143 into memory 112 and/or caches 102, 104 and executed on the CPU 101. The memory or cache may be implemented as multiple storage devices for storing processor readable code to program the processor to perform the methods described herein. The application may present a graphical user interface that provides a consistent user experience when navigating to different media types available on the multimedia console 100. In operation, applications and/or other media contained within the media drive 144 may be launched or played from the media drive 144 to provide additional functionalities to the multimedia console 100.

The multimedia console 100 may be operated as a standalone system by simply connecting the system to a projector, television or other display. In this standalone mode, the multimedia console 100 allows one or more users to interact with the system. However, with the integration of broadband connectivity made available through the network interface 124 or the wireless adapter 148, the multimedia console 100 may further be operated as a participant in a larger network community.

When the multimedia console 100 is powered ON, a set amount of hardware resources are reserved for system use by the multimedia console operating system. These resources may include a reservation of memory (e.g., 16 MB), CPU and GPU cycles (e.g., 5%), networking bandwidth (e.g., 8 kbs), etc. Because these resources are reserved at system boot time, the reserved resources do not exist from the application's view.

In particular, the memory reservation preferably is large enough to contain the launch kernel, concurrent system applications and drivers. The CPU reservation is preferably constant such that if the reserved CPU usage is not used by the system applications, an idle thread will consume any unused cycles.

With regard to the GPU reservation, lightweight messages generated by the system applications (e.g., pop ups) are displayed by using a GPU interrupt to schedule code to render popup into an overlay. The amount of memory required for an overlay depends on the overlay area size and the overlay preferably scales with screen resolution. Where a full user interface is used by the concurrent system application, it is preferable to use a resolution independent of application resolution. A scaler may be used to set this resolution such that the need to change frequency and cause a TV resynch is eliminated.

After the multimedia console 100 boots and system resources are reserved, concurrent system applications execute to provide system functionalities. The system functionalities are encapsulated in a set of system applications that execute within the reserved system resources described above. The operating system kernel identifies threads that are system application threads versus user application threads. The system applications are preferably scheduled to run on the CPU 101 at predetermined times and intervals in order to provide a consistent system resource view to the application. The scheduling is to minimize cache disruption for the application running on the console.

When a concurrent system application requires audio, audio processing is scheduled asynchronously to the user application due to time sensitivity. A multimedia console application manager (described below) controls the application audio level (e.g., mute, attenuate) when system applications are active.

Input devices (e.g., controllers 142(1) and 142(2)) are shared by applications and system applications. The input devices are not reserved resources, but are to be switched between system applications and the application such that each will have a focus of the device. The application manager preferably controls the switching of input streams and a driver maintains state information regarding focus switches. The cameras 26, 28 and capture device 20 may define additional input devices for the console 100 via USB controller 126 or other interface.

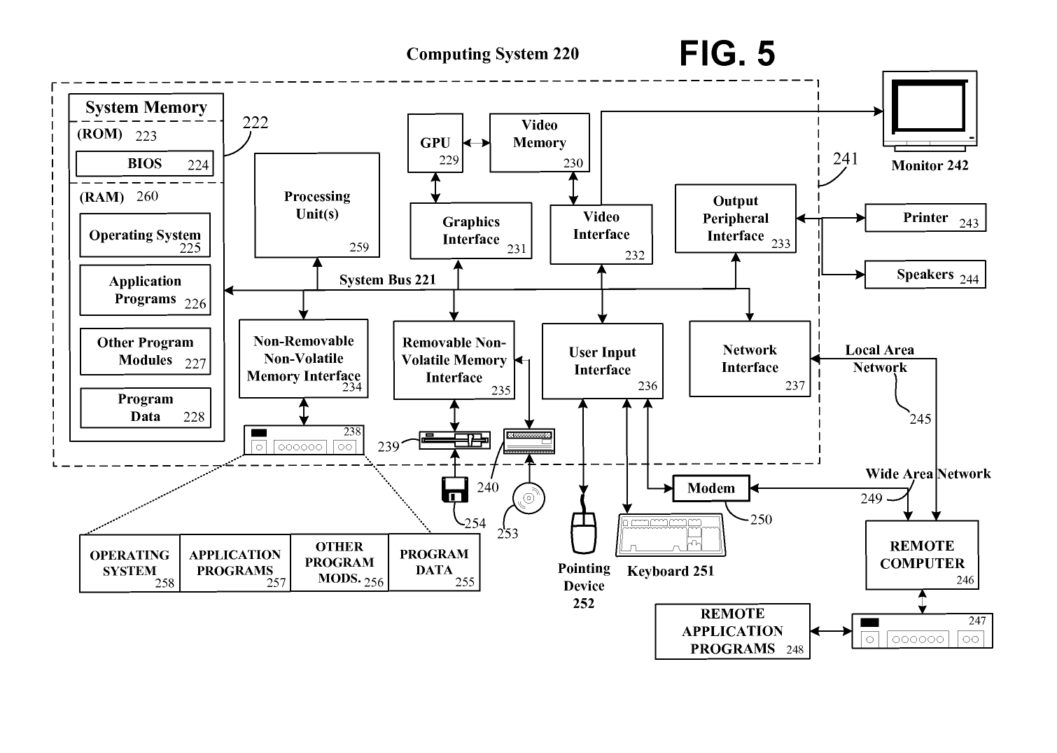

FIG. 5 illustrates another example embodiment of a computing system 220 that may be used to implement the computing system 12 shown in FIGS. 1 and 2. The computing system environment 220 is only one example of a suitable computing system and is not intended to suggest any limitation as to the scope of use or functionality of the presently disclosed subject matter. Neither should the computing system 220 be interpreted as having any dependency or requirement relating to any one or combination of components illustrated in the exemplary operating system 220. In some embodiments the various depicted computing elements may include circuitry configured to instantiate specific aspects of the present disclosure. For example, the term circuitry used in the disclosure can include specialized hardware components configured to perform function(s) by firmware or switches. In other examples embodiments the term circuitry can include a general purpose processing unit, memory, etc., configured by software instructions that embody logic operable to perform function(s). In example embodiments where circuitry includes a combination of hardware and software, an implementer may write source code embodying logic and the source code can be compiled into machine readable code that can be processed by the general purpose processing unit. Since one skilled in the art can appreciate that the state of the art has evolved to a point where there is little difference between hardware, software, or a combination of hardware/software, the selection of hardware versus software to effectuate specific functions is a design choice left to an implementer. More specifically, one of skill in the art can appreciate that a software process can be transformed into an equivalent hardware structure, and a hardware structure can itself be transformed into an equivalent software process. Thus, the selection of a hardware implementation versus a software implementation is one of design choice and left to the implementer.

Computing system 220 comprises a computer 241, which typically includes a variety of computer readable media. Computer readable media can be any available media that can be accessed by computer 241 and includes both volatile and nonvolatile media, removable and non-removable media. The system memory 222 includes computer storage media in the form of volatile and/or nonvolatile memory such as read only memory (ROM) 223 and random access memory (RAM) 260. A basic input/output system 224 (BIOS), containing the basic routines that help to transfer information between elements within computer 241, such as during start-up, is typically stored in ROM 223. RAM 260 (one or more memory chips) typically contains data and/or program modules that are immediately accessible to and/or presently being operated on by processing unit 259. By way of example, and not limitation, FIG. 4 illustrates operating system 225, application programs 226, other program modules 227, and program data 228.

The computer 241 may also include other removable/non-removable, volatile/nonvolatile computer storage media. By way of example only, FIG. 4 illustrates a hard disk drive 238 that reads from or writes to non-removable, nonvolatile magnetic media, a magnetic disk drive 239 that reads from or writes to a removable, nonvolatile magnetic disk 254, and an optical disk drive 240 that reads from or writes to a removable, nonvolatile optical disk 253 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 238 is typically connected to the system bus 221 through a non-removable memory interface such as interface 234, and magnetic disk drive 239 and optical disk drive 240 are typically connected to the system bus 221 by a removable memory interface, such as interface 235.

The drives and their associated computer storage media discussed above and illustrated in FIG. 5, provide storage of computer/processor readable instructions, data structures, program modules and other data for programming computer 241. In FIG. 5, for example, hard disk drive 238 is illustrated as storing operating system 258, application programs 257, other program modules 256, and program data 255. Note that these components can either be the same as or different from operating system 225, application programs 226, other program modules 227, and program data 228. Operating system 258, application programs 257, other program modules 256, and program data 255 are given different numbers here to illustrate that, at a minimum, they are different copies. A user may enter commands and information into the computer 241 through input devices such as a keyboard 251 and pointing device 252, commonly referred to as a mouse, trackball or touch pad. Other input devices (not shown) may include a microphone, joystick, game pad, satellite dish, scanner, or the like. These and other input devices are often connected to the processing unit 259 through a user input interface 236 that is coupled to the system bus, but may be connected by other interface and bus structures, such as a parallel port, game port or a universal serial bus (USB). The cameras 26, 28 and capture device 20 may define additional input devices for the console 100 that connect via user input interface 236. A monitor 242 or other type of display device is also connected to the system bus 221 via an interface, such as a video interface 232. In addition to the monitor, computers may also include other peripheral output devices such as speakers 244 and printer 243, which may be connected through an output peripheral interface 233. Capture Device 20 may connect to computing system 220 via output peripheral interface 233, network interface 237, or other interface.

The computer 241 may operate in a networked environment using logical connections to one or more remote computers, such as a remote computer 246. The remote computer 246 may be a personal computer, a server, a router, a network PC, a peer device or other common network node, and typically includes many or all of the elements described above relative to the computer 241, although only a memory storage device 247 has been illustrated in FIG. 5. The logical connections depicted include a local area network (LAN) 245 and a wide area network (WAN) 249, but may also include other networks. Such networking environments are commonplace in offices, enterprise-wide computer networks, intranets and the Internet.

When used in a LAN networking environment, the computer 241 is connected to the LAN 245 through a network interface or adapter 237. When used in a WAN networking environment, the computer 241 typically includes a modem 250 or other means for establishing communications over the WAN 249, such as the Internet. The modem 250, which may be internal or external, may be connected to the system bus 221 via the user input interface 236, or other appropriate mechanism. In a networked environment, program modules depicted relative to the computer 241, or portions thereof, may be stored in the remote memory storage device. By way of example, and not limitation, FIG. 5 illustrates application programs 248 as residing on memory device 247. It will be appreciated that the network connections shown are exemplary and other means of establishing a communications link between the computers may be used.

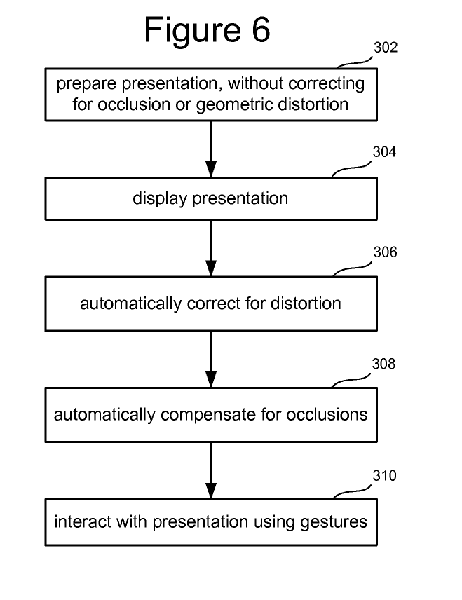

The above-described computing systems, capture device and projector can be used to display presentations. FIG. 6 is a flowchart describing one embodiment of a process for displaying a presentation using the above-described components. In step 302 a user will prepare a presentation. For example, the user can use PowerPoint software by Microsoft Corporation to prepare one or more slides for a presentation. These slides will be prepared without any correction for any potential occlusions or distortion. In step 304, the presentation will displayed. For example, if the user created a presentation using Power Point®, then the user will display a slide show using PowerPoint. The presentation will be displayed using computing system 12, capture device 20 and projector 60. Projector 60, connected to computing system 12, will project the presentation onto a screen, wall or other surface. In step 306, the system will automatically correct the presentation for distortion. For example, if the surface that projector 60 is not level, the screen being projected on is not level or the positioning of the projector with respect to the screen is not at an appropriate angle, the projection of the presentation may be distorted. More details will be described below. Step 306 includes computing system 12 intentionally warping one or more projected images to cancel the detected distortion. In step 308, the system will automatically correct for one or more occlusions. For example, if a presenter (or other person or object) is between the projector 60 and the screen (or wall or other surface) such that a portion of the presentation will be projected on to the person (or object), then that person (or object) will be occluding a portion of the presentation. In step 308, the system will automatically compensate for that occlusion. In some embodiments, more than one occlusion can be compensated for. In step 310, one or more users can interact with the presentation using gestures, as described below. Steps 306-310 will be described in more detail below. Although FIG. 6 shows the steps in a particular order, the steps depicted in FIG. 6 can be performed in other orders, some of the steps can be performed concurrently, and one or more of steps 306-310 can be skipped.

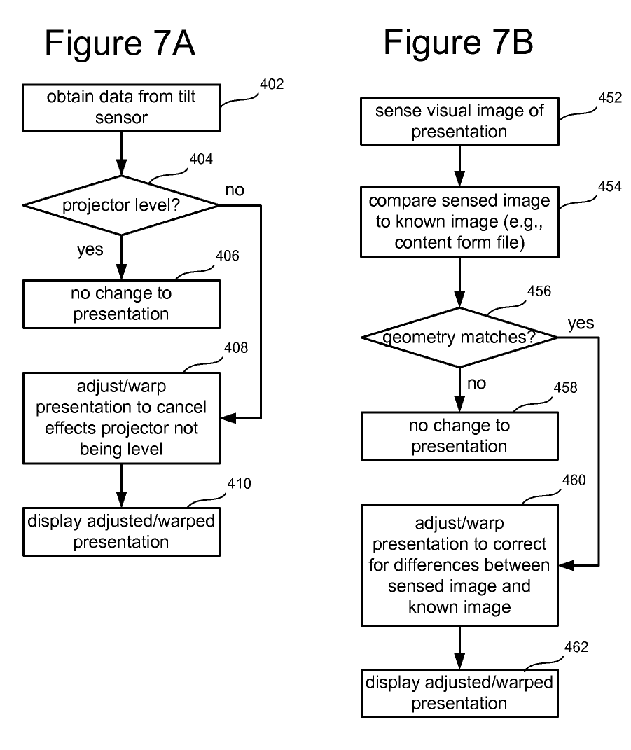

FIGS. 7A and 7B are flowcharts describing two processes for automatically correcting distortion in a presentation. The processes of FIGS. 7A and 7B can be performed as part of step 306 of FIG. 6. The two processes can be performed concurrently or sequentially. In one embodiment, the two processes can be combined into one process.

The process of FIG. 7A will automatically correct a presentation for distortion due to projector 60 not being level. In one embodiment, projector 60 will include a tilt sensor 61 (see FIG. 1 and FIG. 2). This tilt sensor can include an accelerometer, inclinometer, gyro or other type of tilt sensor. In step 402 of FIG. 7A, the system will obtain data from the tilt sensor indicating whether projector 60 is level or not. If projector 60 is level (step 404), then no change needs to be made to the presentation to correct distortion due to the projector being tilted (step 406). If the projector is not level (step 404), then computing system 12 will automatically warp or otherwise adjust the presentation to cancel the effects of the projector not being level in step 408. In step 410, the adjusted/warped presentation will be displayed. The presentation can be adjusted/warped by making one end of the display wider using software techniques known in the art.

In case of a screen that is not perpendicular to the floor, the tilt sensing may not be helpful (e.g., imagine projecting on the ceiling). Using the depth information, it is possible to make sure that the 3D coordinates of the corners of the projection form a prefect rectangle (with right angles) in 3D space. In some embodiments, without using the 3D information, it is possible to fix the distortion only from the point of view of the camera.

FIG. 7B is flowchart describing one embodiment of a process for adjusting/warping a presentation due to the geometry of the surface the presentation is being projected on or due to the geometry of the projector in relation to the surface that the presentation is being projected on. In step 452, the system will sense a visual image of the presentation. As discussed above, capture device 20 will include an image sensor that can capture a visual image (e.g., an RGB image). This RGB image will include an image of the presentation on the screen (or other projection surface). That sensed image will be compared to the known image in step 454. For example, if the presentation is a Power Point presentation, there will be a Power Point file which has the data for defining the slide. Computing system 12 will access the data from Power Point to access the actual known image to be presented and compare the actual known image from the Power Point file to the sensed image from the visual RGB image from capture device 20. The geometry of both images will be compared to see whether the shapes of the individual components and the overall presentation from the known image is the same as in the sensed visual image from step 452. For example, computing system 12 may identify whether an edge of an item in the sensed image is at an expected angle (e.g., the angle of the edge in the actual known image from the Power Point file). Alternatively, computing system 12 may identify whether the visual presentation projected in the screen is a rectangle with right angles.

If the geometry of the sensed image from the visual RGB image from capture device 20 matches the geometry of the actual known image from the Power Point file (step 456), then no change needs to be made to the presentation (step 458). If the geometries do not match (step 456), then computing system 12 will automatically adjust/warp the presentation to correct for differences between the geometry of the sensed image and the actual known image. Determining whether the projector is level (steps 404-404 of FIG. 7A) and comparing the actual known image to the sensed image to see if the geometry matches (steps 452-456 of FIG. 7B) are examples of automatically detecting whether the visually displayed presentation is visually distorted.

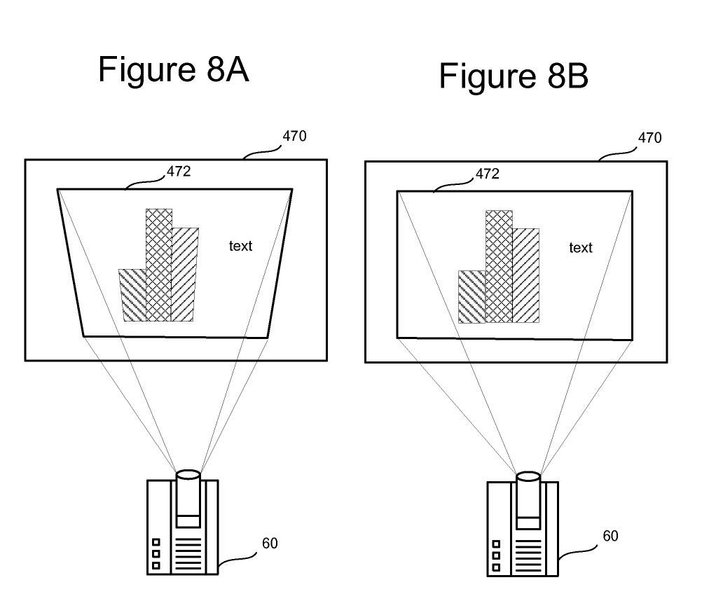

FIGS. 8A and 8B show the adjusting/warping performed in steps 408 and 460. FIG. 8A shows a projector 60 displaying a presentation 472 on a screen (or a wall) 470. Presentation 472 is distorted such as the top of the presentation is wider than the bottom of the presentation. Either step 408 or step 460 can be used to adjust/warp presentation 472. FIG. 8B shows presentation 472 after either step 408 or step 460 adjust/warps presentation 472 to compensate for the distortion. Therefore, FIG. 8B shows presentation 472 as a rectangle with four right angles and the top of the presentation is the same width as the bottom of the presentation. Thus, FIG. 8A is prior to step 408 and/or 460, and FIG. 8B shows after (or the result) of step 408 and/or step 460.

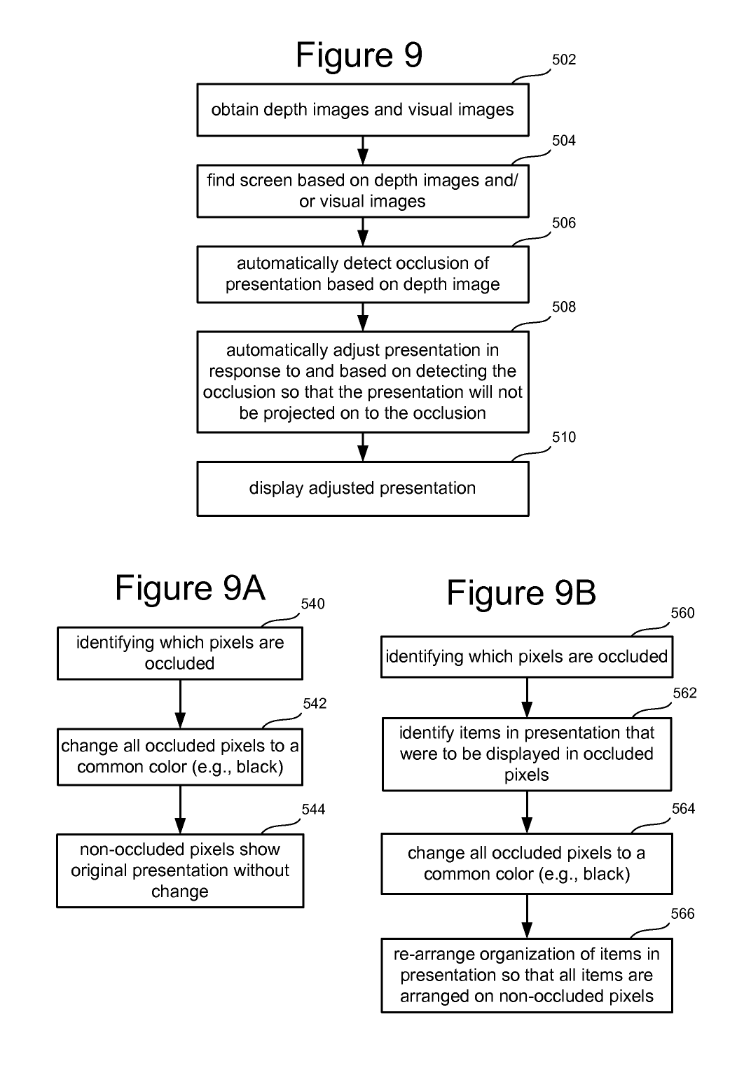

FIG. 9 is a flowchart describing one embodiment of a process for automatically compensating for occlusions. The method of FIG. 9 is one example of implementation of step 308 of FIG. 6. In step 502 of FIG. 9, computing system 12 will obtain one or more depth images and one or more visual images from capture device 20. In step 504, computing system 12 finds the screen (or other surface) that the presentation is being projected on using the depth images and/or visual images. For example, the visual images can be used to recognize the presentation and that information can then be used to find the coordinates of the surface using the depth image. In step 506, computing system 12 will automatically detect whether all or a portion of the presentation is being occluded. For example, if a person is standing in front of the screen (or other surface), then that person is occluding the presentation. In that situation, a portion of the presentation is actually being projected onto the person. When projecting a portion of the presentation onto a person, it will be hard for other people to view the presentation and it may be uncomfortable for the person being projected on. For example, the person being projected on may have trouble seeing with the lights of the projector shining in the person's eyes.

There are many means for automatically detecting whether a presentation is being occluded. In one example, depth images are used to track one or more people in the room. Based on knowing the coordinates of the screen or surface that the presentation is being projected and the coordinates of the one or more persons in the room, the system can calculate whether one or more persons are between the projector 60 and the surface that is being projected on. That is, a skeleton is tracked and it is determined whether the location of the skeleton is between the projector and the target area such that the skeleton will occlude a projection of the presentation on to the target area. In another embodiment, the system can use the depth images to determine whether a person is in a location in front of the projector. In another embodiment, visual images can be used to determine whether there is distortion in the visual image of the presentation that is in the shape of a human. In step 508, computing system 12 will automatically adjust the presentation in response to and based on detecting the occlusion so that the presentation will not be projected onto the occlusion. In step 510, the adjusted presentation will automatically be displayed.

It is possible to detect occlusion per-pixel without using skeleton tracking by comparing the 3D coordinates of the projection to a perfect plane. Pixels the differ a lot from the plane, are considered occluded. It is also possible that some pixels are not occluded, but they're rather farther away from the screen (imagine projecting on a screen that is too small). In that case we can also fix the information to display only on the part that fits a plane.

When determining that the presentation is occluded, the system has at least three choices. First, the system can do nothing and continue to project the presentation onto the occlusion. Second, the system can detect the portion of the screen that is occluded. Each pixel in the slide will be classified into visible/occlude classes. For pixels that are classified as occluded, a constant color (e.g., black) will appear such that the presenter will be clearly visible. Alternatively, pixels displaying the presentation that are classified as occluded can be dimmed. Another benefit is that the presenter will not be dazzled by the bright light from the projector as the pixels aimed at the eye might be shut down (e.g. projected black). Pixels that are not occluded will depict the intended presentation. The third option is that the projection of the presentation will project the presentation only on the un-occluded portions and the presentation will be reorganized so that content that would have been projected on the occlusion will be rearranged to a different portion of the presentation so that that content will be displayed properly.

FIG. 9A is a flowchart that is describes one embodiment of a process for adjusting the presentation so that the presentation will not project onto the occlusion (e.g., the person standing in front of the screen). The method of FIG. 9A is one example implementation of step 508 of FIG. 9. In step 540, computing device 12 will determine which pixels are being projected on the occlusion and which pixels are not being projected on the occlusions. In step 542, all pixels that are being projected on the occlusion will be changed to a common color (e.g., black). Black pixels will appear to be off. Those pixels that are not projected onto the occlusion will continue to present the content that they are supposed to present based on the PowerPoint file (or other type of file). Thus, the non-occluded pixels will show the original presentation without change (step 544).

FIG. 9B is a flowchart describing one embodiment of a process that will project only onto the screen and not onto the occlusion, and also reorganize the content of the slide so that nothing is lost. The process of FIG. 9B is another example of an implementation of step 508. In step 560, computing system 12 will identify which pixels are occluded (similar to step 540). In step 562, computing device 12 will access the original PowerPoint file (or other file) and identify which items of content in the slide were supposed to be displayed in the occluded pixels. In step 564, computing system 12 will change all the occluded pixels to a common color (e.g., black). In step 566, computing system 12 will rearrange the organization of the items in the PowerPoint slide (or other type of file) so that all of the items that are supposed to be in the slide will be in visible portions of the slide. That is, items that were supposed to be projected onto the screen but are being occluded will be moved to other portions of the slide so that they are not occluded. In one embodiment, computing system 12 will access the original PowerPoint file, make a copy of that file, rearrange the various items in a slide, and re-project the slide.

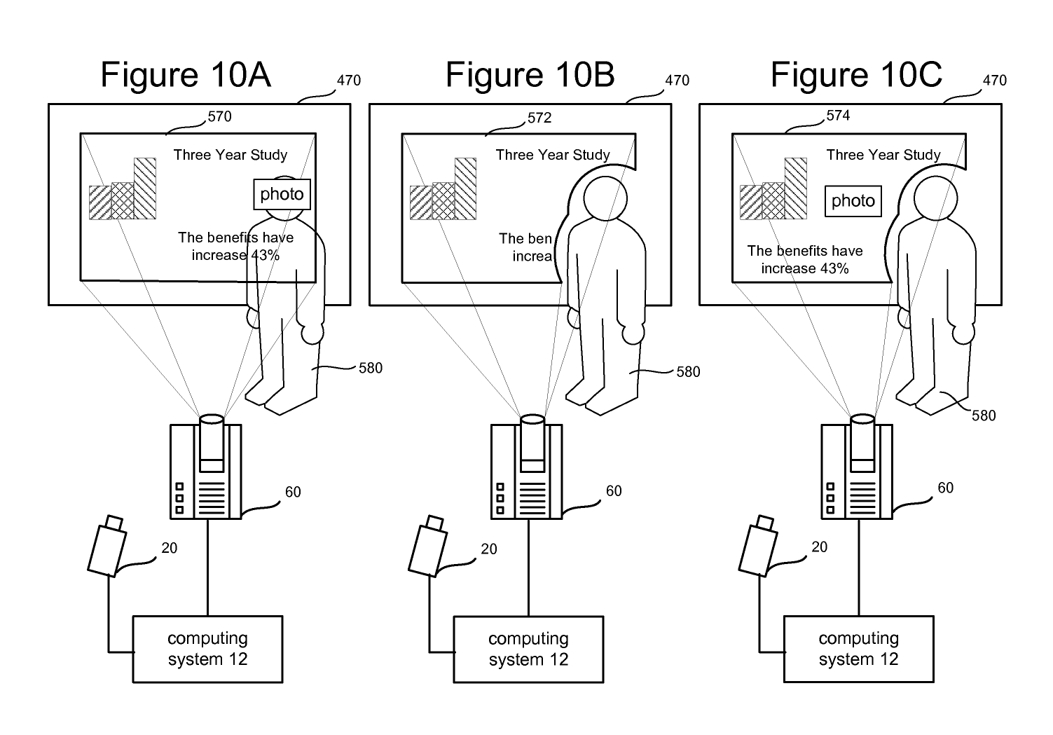

FIGS. 10A-10C provide examples of the effects of performing the process of FIGS. 9A and 9B. FIG. 10A shows a situation prior to performing the processes of FIG. 9A or 9B. Projector 60 displays a presentation 570 on screen 470. Presentation 570 includes a histogram, the title “Three Year Study,” test stating that “The benefits have increased 43%,” and a photo. As can be seen, a portion of the text and the photo are occluded by person 580 such that both are displayed on the person 580. As discussed above, FIG. 9A will change all the occluded pixels to a common color (e.g., black) so that the presentation is not projected onto person 580. This is depicted by FIG. 10B which shows adjusted presentation 572 differing from original presentation 570 such that presentation 572 is not projected onto person 580. Rather, a portion of projector presentation 572 includes black pixels so that the presentation appears to be projected around person 580.

As discussed above, FIG. 9B depicts a process of rearranging items in the presentation so that all items will be displayed around the occlusion. This is depicted by FIG. 10C. FIG. 10A shows the presentation being displayed prior to the process of FIG. 9B and FIG. 10C shows the presentation being displayed after the process of FIG. 9B. As can be seen, presentation 574 is an adjusted version of presentation 570 such that presentation 574 is not projected onto person 580 and the items in presentation 570 have been rearranged so that all items are still visible. For example, the photo that was projected on the head of person 580 has been moved to a different portion of presentation 574 so it is visible in FIG. 10C. Additionally, the text “The benefits have increased 43%” has been moved so that all the text is visible in presentation 574.

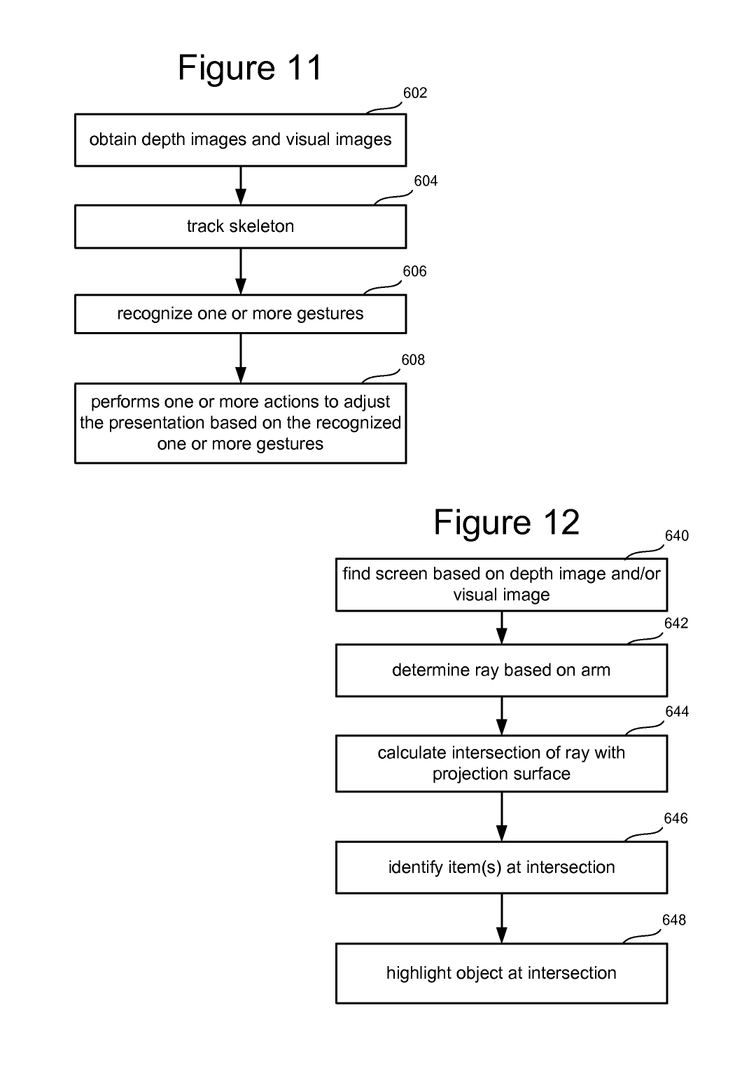

FIG. 11 is a flowchart describing one embodiment of a process for interacting with the presentation using gestures. The process of FIG. 11 is one example implementation of step 310 of FIG. 6. In step 602 of FIG. 11, computing system 12 will obtain one or more depth images and one or more visual images from capture device 20. In step 604, computing system 12 will track one or more skeletons corresponding to one or more persons in the room, using the technology mentioned above. In step 606, computing system 12 will recognize one or more gestures using recognizer engine 54 and the appropriate filters. In step 608, computing system 12 will perform one or more actions to adjust a presentation based on the recognized one or more gestures. For example, if the computing system 12 recognizes a hand movement from right to left, computing system 12 will automatically advance a presentation to the next slide. If the computing system recognizes a hand motion waving from left to right, the system will move the presentation to the previous slide. Other gestures and other actions can also be utilized.

Another gesture that can be recognized by computing system 12 can be a human pointing to a portion of the presentation. In response to that pointing, the computing system can adjust the presentation to highlight the portion of the presentation being pointed to. FIG. 12 is a flowchart describing one embodiment for performing a method of recognizing a user pointing to a portion of the presentation and highlighting that portion of the presentation. The process of FIG. 12 is one example implementation of step 608 of FIG. 11. In step 640 of FIG. 12, computing system 12 will find the screen that the presentation is being projected on (or other surface being projected on) using one or more depth images and one or more visual images. For example, a visual image can be used to identify where the presentation is and then the depth image can be used to calculate the three dimensional location of the surface being projected on. In step 642, computing system 12 will use the skeleton information discussed above to determine the direction of the user's arm so that computing system 12 can determine a ray (or vector) emanating from the user's arm along the axis of the user's arm. In step 644, computing system 12 will calculate an intersection of the ray with the surface that the presentation is being projected on. In step 646, computing system 12 will identify one or more items in the presentation at the intersection of the ray and the projection surface. Computing system 12 identifies the portion of the presentation being pointed to by the human by converting the real world three dimensional coordinates of the intersection to two dimensional coordinates in the presentation and determining what items are at the position corresponding to the two dimensional coordinates. Computing system 12 may access the PowerPoint file to identify the items in the presentation. In step 648, the identified items at the intersection will be highlighted.

There are many different way to highlight an object in a presentation. In one embodiment, the item can be underlined, have its background changed, become bold, become italicized, circled, change have a cloud or other object in front of it that is partially see-through, change color, flash, be pointed to, be animated, etc. No one type of highlight is required.

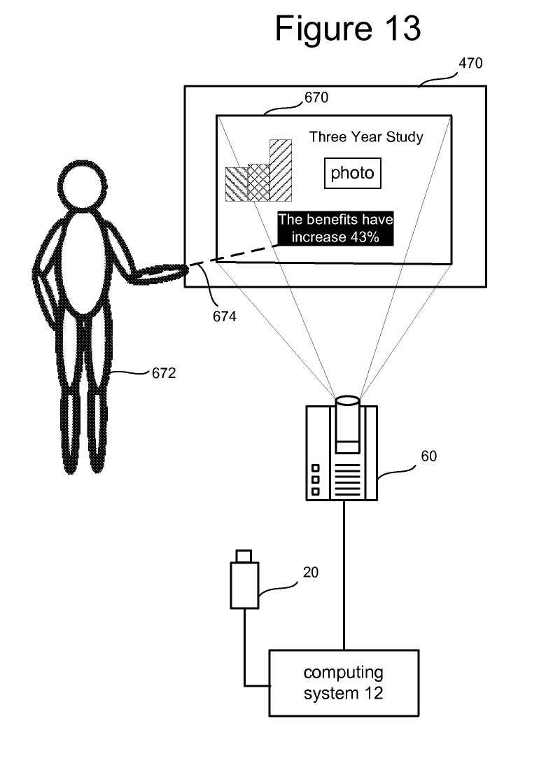

FIG. 13 shows one example of the result of the process of FIG. 12, highlighting an object at the intersection of the ray and the projection surface. As can be seen, projector 60 is projecting a presentation 670 on surface 470. A human presenter 672 is pointing to presentation 670. FIG. 13 shows the ray 674 (dashed line) from the user's arm. In an actual implementation, the ray will not be visible. Ray 674 points to presentation 670. Specifically, at the intersection point of ray 674 and projection surface 470 is the text “The benefits have increased 43%.” To highlight that text (the original text was black ink on a white background), the background has changed color from white to black and the text has changed color from black to white (or another color). Many other types of highlighting can also be used.

The above-described techniques for interacting with and correcting presentations will allow presentations to be more effective.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. It is intended that the scope of the invention be defined by the claims appended hereto.

We claim:

1. A method for displaying content, comprising:
displaying a visual presentation;
automatically detecting that the displayed visual presentation is visually distorted; and
automatically correcting the displayed visual presentation to fix the detected distortion.

2. The method of claim 1, wherein:
the automatically correcting the displayed visual presentation to fix the detected distortion includes intentionally warping one or more projected images to cancel the detected distortion and displaying the warped one or more projected images.

3. The method of claim 1, wherein:
the automatically detecting that the displayed visual presentation is visually distorted includes using a physical sensor to detect that a projector is not level.

4. The method of claim 1, wherein:
the automatically detecting that the displayed visual presentation is visually distorted includes sensing a visual image of the visual presentation and identifying whether an edge of the visual presentation is at an expected angle.

5. The method of claim 1, wherein:
the automatically detecting that the displayed visual presentation is visually distorted includes sensing a visual image of the visual presentation and identifying whether the visual presentation is a rectangle with right angles.

6. The method of claim 1, wherein:
the displaying the visual presentation includes creating one or more images based on content in a file; and
the automatically detecting that the displayed visual presentation is visually distorted includes sensing a visual image of the visual presentation and determining that the sensed visual image does not match the content in the file.

7. The method of claim 1, wherein:
the displaying the visual presentation includes creating one or more images based on content in a file;
the automatically detecting that the displayed visual presentation is visually distorted includes sensing a visual image of the visual presentation and determining whether the sensed visual image matches the content in the file; and
the automatically correcting the displayed visual presentation to fix the detected distortion includes intentionally warping one or more projected images to correct a difference between the sensed visual image and the content in the file, the automatically correcting the visual displayed presentation further includes displaying the warped one or more projected images.

8. The method of claim 7, further comprising:
receives depth images from a depth camera;
recognizing one or more gestures made by a human based on the depth images; and
performs one or more actions to adjust the presentation based on the recognized one or more gestures.

9. An apparatus for displaying content, comprising:
a processor;
a display device in communication with the processor;
a depth camera in communication with the processor, the processor receives depth images from the depth camera and recognizes one or more gestures made by a human in a field of view of the depth camera; and
a memory device in communication with the processor, the memory device stores a presentation, the processor causes the presentation to be displayed by the display device, the processor performs one or more actions to adjust the presentation based on the recognized one or more gestures.

10. The apparatus of claim 9, wherein:
the presentation includes a set of slides; and
the one or more actions includes changing slides in response to a predetermined movement of the human.

11. The apparatus of claim 9, wherein:
the presentation includes a set of slides;
the processor recognizes that the human is making a sweeping motion with the human's hand; and
the processor changes slides in response to recognizing that the human is making the sweeping motion with the human's hand.

12. The apparatus of claim 9, wherein:
the one or more gestures includes the human pointing to a portion of the presentation;
the one or more actions to adjust the presentation includes highlighting the portion of the presentation being pointed to by the human; and
the processor recognizes that the human is pointing and determines where in the presentation the human is pointing to.

13. The apparatus of claim 12, wherein:
the processor determines where in the presentation the human is pointing to by calculating an intersection of a ray from the humans' arm and with a projection surface for the presentation.

14. The apparatus of claim 13, wherein:
the processor highlights the portion of the presentation being pointed to by the human by converting the real world three dimensional coordinates of the intersection to two dimensional coordinates in the presentation and adding a graphic based on the two dimensional coordinates in the presentation.

15. The apparatus of claim 14, wherein:
the processor highlights the portion of the presentation being pointed to by the human by highlighting text.

16. One or more processor readable storage devices having processor readable code embodied on the one or more processor readable storage devices, the processor readable code for programming one or more processors to perform a method comprising:
receiving a depth image;
automatically detecting an occlusion between a projector and a target area using the depth image;
automatically adjusting a presentation in response to and based on detecting the occlusion so that the presentation will not be projected on the occlusion; and
displaying the adjusted presentation on the target area without displaying the presentation on the occlusion.

17. The one or more processor readable storage devices of claim 16, wherein:
the displaying the adjusted presentation on the target area without displaying the presentation on the occlusion comprises:
displaying content of the presentation on the target area, and
displaying a predetermined color, that is not part of the presentation, on the occlusion; and
the automatically adjusting the presentation includes changing some pixels from the content of the presentation to the predetermined color.

18. The one or more processor readable storage devices of claim 17, wherein:
the automatically adjusting the presentation includes automatically reorganizing content in the presentation by changing position of one or more items in the presentation.

19. The one or more processor readable storage devices of claim 17, wherein:
the automatically detecting the occlusion includes identifying and tracking a skeleton and determining that the location of the skeleton is between the projector and the target area such that the skeleton will occlude a projection of the presentation on to the target area.

20. The one or more processor readable storage devices of claim 16, wherein:
the automatically adjusting the presentation includes dimming some pixels from the content of the presentation.
